(19) United States
(12) Patent Application Publication
(10) Pub. No.: US 2008/0249886 A1
(43) Pub. Date: Oct. 9, 2008

(54) Satellite radio-based on-demand purchase system

(76) Inventor: William A. Woodard, Encinitas, CA (US)

Correspondence Address: FULWIDER PATTON LLP, 6060 CENTER DRIVE, 10TH FLOOR, LOS ANGELES, CA, 90045, US

(21) Appl. No.: 11/732,329

(22) Filed: Apr. 3, 2007

(51) Int. Cl. H04B 1/28

(52) U.S. Cl. 705/26; 455/3.02; 700/234

(57) ABSTRACT

A system for purchasing and downloading an audio file broadcasted through a satellite network to a predetermined storage device. The system includes a hub site containing a resident database of audio file content, transmission means, a satellite network for transmitting the audio files to subscribers, a portable satellite transceiver unit for receiving the satellite broadcasts, a purchase request function and signal for notifying the hub site of the subscriber's desire to purchase the broadcast audio file, and a storage device for receiving a download of the audio file from the hub site.

### BACKGROUND OF THE INVENTION

1. Field of the Invention

The invention relates to the field of satellite radio transmissions and more specifically, data content purchase and downloading.

2. Background of the Prior Art

Since the inception of mass radio broadcasting, when audiences gathered as families near a family radio reception box to listen to audio theatre or popular music and songs, listeners have yearned to be capable of recording an appealing piece to subsequently have access thereto even after forgetting the name of the piece or having failed to note the name of the work or of the artist. As broadcasting evolved, audio tastes, in many cases, have become heavily music oriented. To acquire a copy of a recording, an aficionado must necessarily be capable of identifying the work or artist and then may be forced to either buying an entire physical copy of an album or if the song was particularly popular, a single version may be available. However, when distributed in singles, the audio works often proved to be particular expensive and sometimes unprofitable for some music labels. Singles require a physical medium to themselves and the cost of recording a single song on vinyl or cassette proved to be somewhat cost prohibitive.

With the advent of modern recording mediums capable of storing vast quantities of data on to a single piece, such as compact or digital video disks, when a single song is released some may consider such releases an inefficient distribution of recording material. Many albums contain what some consider fluff material or just one or two good songs and listeners long for the ability to select certain individual choice audio selections and to store them to a medium of access convenient to their listening pleasure without the need of cumbersome storage equipment or furniture such as disc towers.

Numerous creative solutions to this dilemma involve accessing the Internet or some other audio file distributor who has licensed to distribute numerous audio files to those willing to pay a subscription or per file fee. One current resource available to assist listeners with the acquisition and storage of computer files is the Internet. Peer-to-peer distribution and file sharing became popular means for those looking to access a specific file and store it on their personal computer. Content providers soon realized that a market was available for distributing single files at a low price directly to users and their personal computers. Audiophiles were now able to listen to hundreds of the songs or audio works of choice in the convenience of their own home without the need for storing the physical albums or CDs. However, access to their files was limited to the desktop at home or to their laptop computers. As will be recognized, laptops are generally a heavy and impractical means for carrying and accessing audio files in comparison to other available means.

Convenient access to audio files evolved in the form of portable electronic devices such as personal digital assistants, iPods, and MP3 players. Devices such as these allow an individual to download and record specific individual files and mix-and-match various artists' work within one large database in a compact, convenient storage both readily accessible and transportable. Once again such devices involved linking to computer or an electronic database module where selected files are chosen and then downloaded into the memory banks of the device through a communication line. The process involved setting aside time for the consumer to sit down and browse through a list catalogue of files to locate either known selections in mind or after browsing through snippets of available files, selecting files and purchasing them for download into their personal computer. The files were then transferred from the computer to another desired portable listening device should the consumer wish to listen to the files away from their computer.

Other convenient solutions to hearing audio files while in transit involve digital broadcasting of audio files from either land-based or satellite based terminals. Satellite-based systems have grown in popularity primarily because of their ability to transmit audio files over large regions of area without having to tune between fading station signals. For example, an individual listening to a satellite-based radio signal tuned in to station 108 will be able to listen to that same station as they travel from one region of the country to another. Currently three services offer satellite-based radio programming: XM, Sirius, and Worldspace. Currently only XM and Sirius satellite radio are available in the United States. Each service is provided through subscription and individual subscribers pay monthly fees for access to specific radio contact. Typically these subscription services are available on mobile devices, for example, radio tuner units installed within an automobile. As the driver of an automobile is traveling along, he or she switches between broadcast stations until a particular desirable song, or talk radio show, etc. is found. The driver listens to the particular piece of work until it ends and continues listening to subsequent audio files or ceases the transmission. If the driver wants to listen to a predetermined work they may have in mind, they are forced to locate a compact disc or other physical medium containing the work and insert it into the appropriate player.

It can be seen then that a need exists for a system that can readily purchase, access and download a broadcast digital audio file in real time to a predetermined storage medium.

### SUMMARY OF THE INVENTION

Briefly and in general terms, an on-demand purchase system of the present invention includes a satellite transceiver unit, a centralized data hub site, a computer server, a catalogue of digital audio files, a subscriber designated digital storage device, and an audio file transmitted to the transceiver where it is listened to by the end user subscriber.

In one embodiment, a digital audio file is transmitted from a satellite to a satellite transceiver unit of the subscriber. The subscriber listens to audio files until he or she encounters a file desired for purchase and storage for future listening purposes. The audio files transmitted from the satellite to the individual subscriber transceiver contain associated audio file identifier data recognizable by the transceiver unit. Should the subscriber elect to make a purchase, he or she will initiate a function that transmits a signal from the transceiver to the satellite which, in turn transmits the request along with the identifying audio information data to the centralized data hub site. The data hub site includes within its infrastructure a computer server including a catalogue content of preset audio files. The server also includes a database containing subscriber information identifying subscribers, their individual pricing plans and list of stored electronic storage devices associated with each subscriber. Upon receipt of the request, the server initiates the search function locating the requested audio file data using the identifying audio file information. Once located, the audio file is uploaded back to the server and transmitted by transmission means to the subscriber's determined storage device by means depending on the type of the device selected.

As recognized by those of skill in the art, the satellite transceiver can be manufactured for portability and may be coupled to an existing radio tuner device for adaptation to an augmented radio apparatus. For example, the satellite transceiver may be detachably connected to an automobile radio and tuner unit coupled to an antenna and capable of receiving and decoding satellite transmitted signals. The signals may contain information regarding the song such as the artist, the title, and a particular version. The transceiver may contain a memory chip and program to decode the signals received from the satellite and would further include personal information regarding the subscriber such as the subscriber name, the subscription plan, and digital data storage devices identified as well as their locations.

In one embodiment, the purchase and download of a particular audio file will be initiated by a one-touch function preprogrammed on the satellite transceiver unit. Selecting the function will automatically identify the song currently broadcast, transmit the associated audio file data information, where such information will be retransmitted to the centralized hub site along with the pre-stored subscriber information and preselected digital storage device.

Other features and advantages of the invention will become apparent from the following detailed description, taken in conjunction with the accompanying drawings which illustrate, by way of example, the features of the invention.

### BRIEF DESCRIPTION OF THE DRAWINGS

FIG. 1 is a schematic depicting a satellite radio system for requesting and downloading files;

FIG. 2 is a flow diagram depicting a method using the system shown in FIG. 1;

FIG. 3 is a depiction of a radio tuner unit used in the system of FIG. 1;

FIG. 4 is a depiction of a radio tuner unit used in the system of FIG. 1; and

FIG. 5 is a functional block diagram depicting the satellite system shown in FIG. 1.

### DETAILED DESCRIPTION OF THE PREFERRED EMBODIMENTS

Consumers typically seek simplicity, user-friendliness, and a quick response from their electronic equipment. Often, the consumer believes electronic devices should make life easier by placing desirable functions ideally within the touch of a button. The less activity by the consumer, the more portable the devices, and the less equipment required for desired features, the more desirable the particular equipment. For example, audiophiles and in general, audio consumers have in the past sought smaller portable devices for simple access to their music and the like. From portable stereos, to handheld cassette players and disc players to cellular telephones and flash memory devices such as personal digital assistants, the trend has appeared to move consistently towards easier access to files and increased file storage capacity. Currently, the consumer has the ability to access and store thousands of predetermined files with the ability to later access them on compact portable devices on both their person and within their vehicles. One preferable advancement in audio file access then, is the ability to purchase, download and save files during their broadcast or soon thereafter.

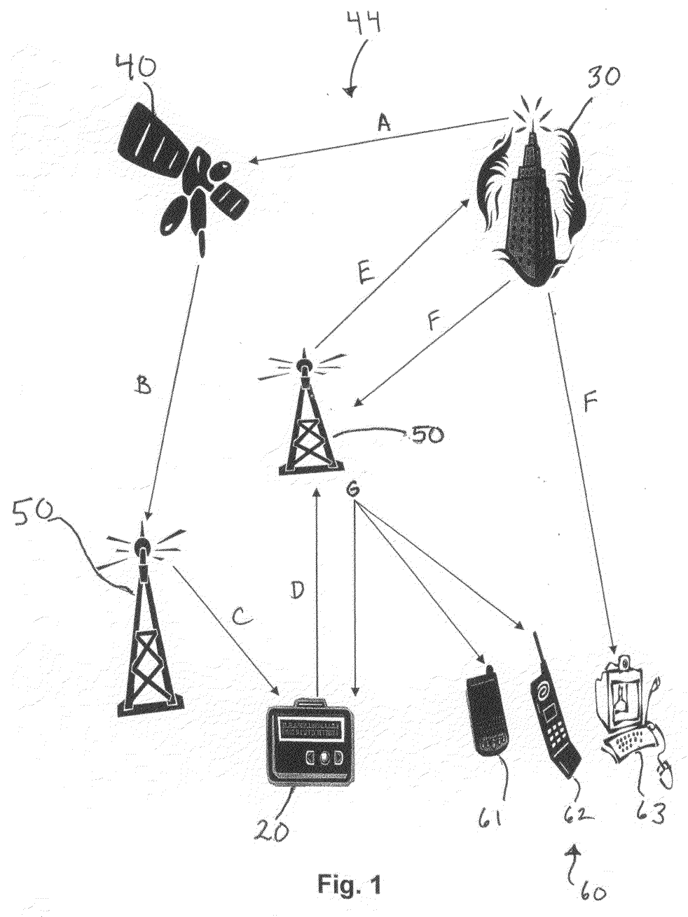

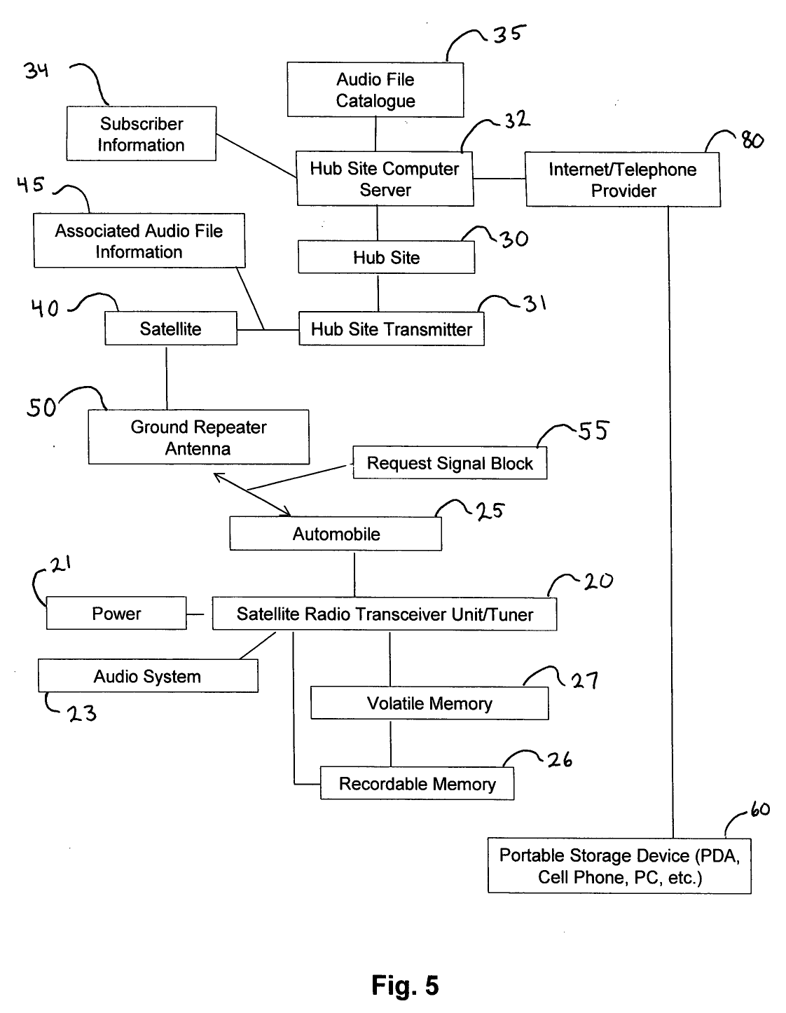

Referring to FIGS. 1 and 5, one example of a system for providing download access to broadcasted audio files 44 broadcast to a portable signal receiving device is depicted. One configuration of the system includes a portable transceiver unit 20 in signal communication with a centralized hub site 30. The portable transceiver unit 20 is a device capable of receiving satellite broadcast signals where the device may be either a fixed apparatus stationed within, for example a domicile, or instead be portable, carried by the person or installed within another portable device, such as an automobile 25. The centralized hub site 30 is a broadcasting station equipped with a transmitter and a centralized computer server 35 coordinated for selecting broadcast file lineups and retrieving digital audio files from a digital audio file catalogue 35 resident on the server. The system further includes a signal relay for transmitting a satellite signal from the hub site 30 to a subscribing consumer that typically includes a relay satellite 40 and where necessary, ground repeaters 50 for receiving the satellite signal and amplifying a relay of the signal to individual subscriber transceiver units. Further defining the system is a recordable digital storage device 60 capable of receiving either wireless or hardwired transmitted data from the hub site.

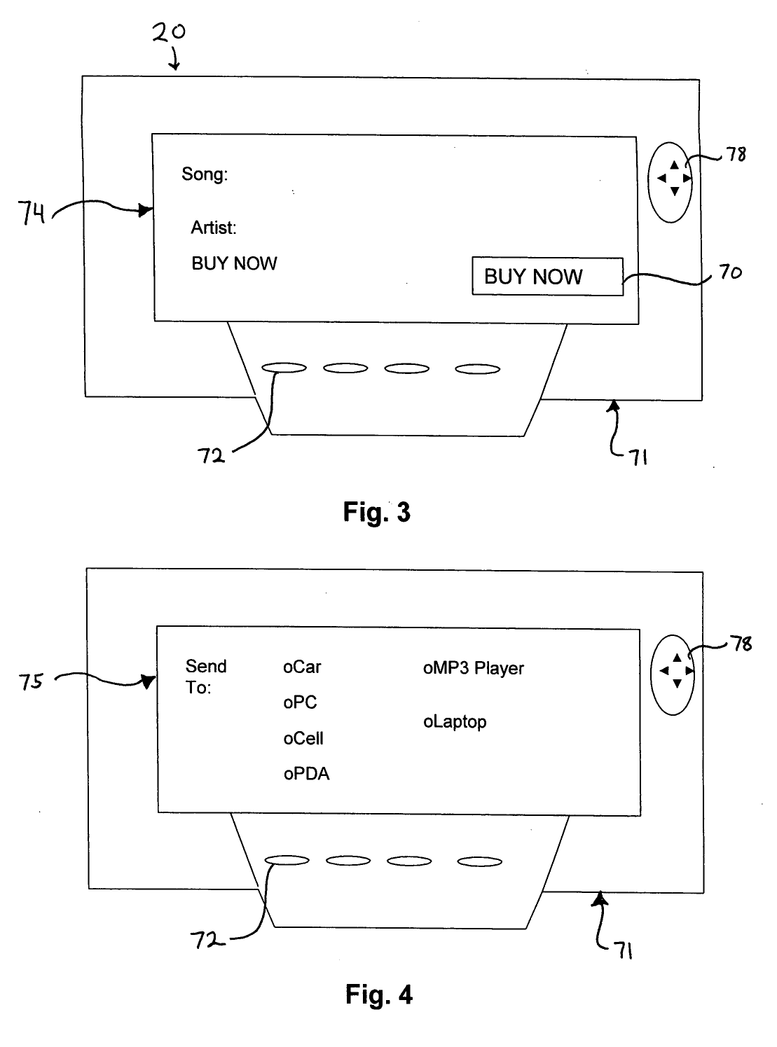

The transceiver unit 20 in a preferred embodiment, is a satellite radio tuner mounted within a handheld device or an automobile 25. The transceiver unit 20 is subscribed to a satellite radio broadcast service and may be coupled to an automobile's audio system 23 and power source 21 or in some cases, employ stand-alone power and audio means. The transceiver unit 20 receives digital audio data files 44, tuning into specific satellite transmission frequencies, decoding encoded digital audio data, playing the audio data into a recognizable audio format, and transmitting a signal to a radio receiving apparatus. The tuner unit 20 will include both a recordable memory 26 for recording subscriber information and for storing digital audio files and a volatile memory 27 for temporary retention of broadcast audio files and associated information. Referring to FIGS. 3-4, the transceiver unit includes a user interface 71 including interface controllers 72 and 78 for tuning into various frequencies and selecting predetermined functions within the unit. Included within the various selections may be a list of any number of predetermined digital storage devices 60, with each individual device selection including individually stored information such as telephone number, internet protocol address, etc. that identifies the device and it's location.

The hub site 30 is a broadcasting headquarters for coordinating the retrieval, transmission, and distribution of audio files 44 to subscribers. The hub site 30 includes a transmitter 31 for transmission of digital audio signals to a satellite 40 and a computer server 32 containing a preset catalogue 35 of licensed audio files for broadcast and distribution to subscribers. The server may also include audio file broadcast lineups, a subscriber information database 34, and retrieval means for locating requested audio files. The preset catalogue 35 of audio files is comprised of pre-licensed songs and other audio content ready for transmission and redistribution upon request. The hub site 30 may further include both wireless and wired communication means for receiving and transmitting requests from and to subscribers.

The system includes any of a number of predetermined digital storage devices 60 preselected by the subscriber. It will be recognized by those of ordinary skill in the art that the storage device 60 may consist of any digital recording device capable of receiving either a wireless or wired signal. For example, the subscriber may store and elect several different devices capable of receiving transmitted digital information from the hub site such as a personal digital assistant 61, a cellular telephone 62, a personal computer 63, and the tuner unit 20 itself or other handheld device. The storage devices may either be in hard wire communication with the hub site through telephone lines or in wireless communication with means to communicate with the ground repeaters 50 or through cellular antenna means.

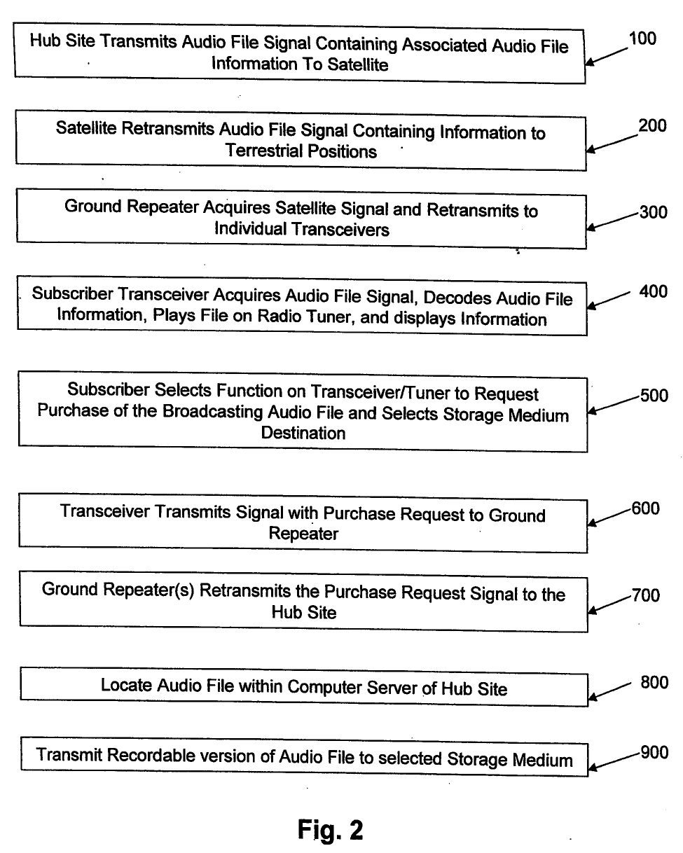

In operation, it will be appreciated that the system for purchasing and downloading a broadcasted audio file provides a convenient and flexible means for storing desirable audio files. Referring to FIG. 2, in general, the system begins with an audio file 44 broadcast by the hub site 30 through it's transmitter 31 to satellites 40 orbiting over the Earth in a satellite network retransmitting the signal to the numerous subscribers tuned into the broadcasting frequency. It will be understood that some areas may require amplified signal strength and that ground repeating signal stations 50 may be required to transmit a signal to subscribing tuner units 20. A listening subscriber will be in some cases, driving around in his or her car tuning in and out of broadcast stations until he or she hears a pleasing performance. The discerning listener will often want to hear through the performance's entirety until they have decided whether or not to select the performance for purchase and download. Typically, the listener will continue listening through multiple songs but the moment a new song catches the subscriber's ear or the subscriber encounters an old favorite, he or she has the option to request its purchase and have the file downloaded to a preselected digital storage device 60. The subscriber selects a function on the tuner unit 20 that transmits a purchase request 54 through a radio signal to a ground repeater 50 that in turn retransmits the request signal to the hub site 31 or the tuner instead may be coupled to a cellular telephone service that calls in the request to the hub site. Upon receiving the subscriber request, the hub site will locate a stored version of the audio file and transmit it to the selected storage device 60.

As will be appreciated by those of skill in the art the system eliminates an unnecessary delay in acquiring rights to audio files and in transmitting information to the subscriber by pre-storing available files on the computer server 32 and by transmitting associated file information 45 during the broadcast. The subscribing consumer has convenient access to desired audio files 44 which are predetermined and pre-existing on the hub site computer server 32. The audio files contain associated file identification information 45 that is broadcast along with the audio portion of the file so that when the broadcast of the file is tuned to a site, the identification information is readily displayed for the subscriber on the radio tuner unit 20 user interface 71. Other information such as the file number, location on server, and proprietary rights may be transmitted but left unseen to the subscriber. The associated file information 45 may be temporarily stored on the tuner unit volatile memory 27 until a predetermined time after broadcast or until the file is requested and stored. The audio files will be readily available and the time associated with purchasing and downloading the files will be as fast as sending the electronic request from the tuner unit 20 to the hub site 30 and likewise in sending the file from the hub site 30 through the communication means to the storage device 60.

For example, referring to FIGS. 3 and 4, a preferred embodiment includes a “Buy Now” feature 70 available on the tuner unit 20. The “Buy Now” function will include several predetermined data so that when selected, the currently broadcast audio file may be instantly requested, purchased and downloaded to a storage device 60. Those skilled in the art will recognize that the purchase process may commence with a selection on the digital screen or through a preprogrammed button on the unit. When the broadcasted audio file is received and tuned into, the transmitted associated file information is displayed on the tuner unit interface 71. A “Buy Now” screen 74 or equivalent screen may display portions of the associated file information 45 such as the audio file title (Song), the name of the Artist, and the purchase price. It will be understood by those of ordinary skill in the art that the price will depend on subscription plans and may include, for example, pricing per download or flat rate unlimited downloads per month. When the listener decides to purchase the file, it will be understood that the storage device 60 may be preset at a default device such as a cellular telephone 62 or that the subscriber may opt to request download to another or multiple devices by switching to an optional screen 75 and selecting, for example, simultaneous download transmissions to the tuner unit 20 where the subscriber is located, personal digital assistant 61 located in the subscriber's office, and personal computer 63 located at the subscriber's domicile.

Once the “Buy Now” function is selected, the request is transmitted from the tuner unit 20 to the hub site 30 through a request signal block 55. The request signal block 55 includes data such as the requested audio file for purchase extrapolated from the volatile memory 27 on the tuner unit 20, the subscriber information including identity, subscription plan, etc. and storage device 60 information such as device type and device information. Once the request signal block 55 is received by the hub site 30, it is processed by the computer server 32 where subscriber information may be verified and the storage device 60 information accessed from the subscriber information database 34 in order to properly direct the download of the audio file 44 located from the preset catalogue 35. It will be recognized by those of ordinary skill in the art that by accompanying the broadcast audio file 44 with an associated file identification information 45 temporarily stored on the tuner unit 20, the audio file 44 may be instantly transferred from the volatile memory 27 to the recordable memory 26 on the tuner unit 20 upon verification of the subscriber information in the request signal block. Those skilled in the art will recognize that varying storage devices may require individual data storage formats and that the computer server will be operative to recognize the preferred formats for each individual device.

It will also be recognized that the system is facilitated by an accompanying business method that streamlines acquisition of data content by collaborating with content providers to have predetermined pricing and access to audio data files. The business method may solicit partnerships with digital media providers and distributors that have pre-approved clearance with artists and representatives to distribute the content. The business model will license content from individuals or in bulk from other content providers to establish a stored database of content resident on the hub site 30 computer server. Subscribers will be electronically identified and audio file preferences may be tracked. Payment of royalties to artists and content providers may be electronically recorded and submitted to designated accounts. With the pre-authorization of audio file content, it will be recognized that questions regarding legal publishing and distribution availability will, in many cases, be identified and managed before audio files are included in the catalogue. The stored content may then be readily accessed for broadcast and if purchased, may be downloaded directly from the hub site through communication means to the end destination.

Those of ordinary skill in the art will appreciate that minor modifications and alterations will be possible without deviating from the scope of the invention, and said modifications and alterations are intended to be included in the scope of the invention.

We claim:

1. A system for purchasing and downloading a currently broadcast digital audio file data to a subscriber, comprising:
an audio data content hub site;
a computer server electronically coupled to the hub site;
a catalogue of digital audio data stored on the computer server;
a satellite in operative communication with the hub site for receiving a transmission of the audio data file;
a satellite transceiver unit in operative communication with the satellite;
a relay signal retransmitting the audio data file from the satellite to the transceiver unit;
a purchase request signal generated by the transceiver unit;
transmission means for transmitting the purchase request signal from the transceiver to the hub site; and
a predetermined digital storage device including means to receive a download of the audio data file.

2. The system for purchasing and downloading a currently broadcast digital audio file of claim 1, wherein:
the computer server includes a database of stored subscriber information accessed when the hub site receives a purchase request signal.

3. The system for purchasing and downloading a currently broadcast digital audio file of claim 1, wherein:
the purchase request signal includes a subscriber information block including subscriber information and audio data file information.

4. The system for purchasing and downloading a currently broadcast digital audio file of claim 1, further comprising:
a purchase request function selectable from the transceiver unit and operable to gather and transmit the stored subscriber information, the audio file data, and the predetermined digital storage device from a single selection on the transceiver unit.

5. The system for purchasing and downloading a currently broadcast digital audio file of claim 1, wherein:
the storage device is selected from one or more of a personal computer, a personal digital assistant, a cellular telephone, an iPod®, or the transceiver unit.

6. The system for purchasing and downloading a currently broadcast digital audio file of claim 1, wherein:
the download means include a wireless signal receiver operative to receive the download of data.

7. The system for purchasing and downloading a currently broadcast digital audio file of claim 1, wherein:
the transceiver unit includes a volatile memory and a recordable memory.

8. The system for purchasing and downloading a currently broadcast digital audio file of claim 1, wherein:
the transceiver unit is mounted in electrical connection to an automobile radio tuner.

9. The system for purchasing and downloading a currently broadcast digital audio file of claim 1, wherein:
the transceiver unit is mounted in electrical connection to a handheld radio tuner.

10. The system for purchasing and downloading a currently broadcast digital audio file of claim 1, further comprising:
one or more ground repeater antennas operative to relay and amplify the satellite transmissions to the transceiver unit.

11. The system for purchasing and downloading a currently broadcast digital audio file of claim 10, wherein:
the ground repeater antennas are further operative to retransmit the purchase request signal from the transceiver to the hub site.

12. The system for purchasing and downloading a currently broadcast digital audio file of claim 1, further comprising:
an associated file information block transmitted with the audio file and received by the transceiver unit.

13. The system for purchasing and downloading a currently broadcast digital audio file of claim 12, wherein:
the transceiver unit includes an electronic display and at least a portion of the associated file information is shown on the display.

14. A method of selling digital audio files to satellite broadcast subscribers, including:
acquiring licensed digital audio files comprising an accessible and distributable catalogue of audio files;
broadcasting the digital audio files from the catalogue to the subscribers through a signal using a satellite service;
providing reception means responsive to subscriber requests of a broadcast audio file;
locating the selected audio files identified in the subscriber request within the catalogue; and
transmitting a downloadable version of the audio file to a preselected storage device identified by the subscriber.

15. The method of selling digital audio files in claim 14, wherein:
the satellite service includes a satellite transceiver unit operative to receive and transmit digital signals.

16. The method of selling digital audio files in claim 14, wherein:
the broadcasting of audio files is performed through a satellite and ground repeater system operative to transmit and receive signals.

17. The method of selling digital audio files in claim 14, wherein:
the step of broadcasting through the satellite service includes receiving the signal through a preprogrammed satellite tuner operative to decode the satellite transmission signal and play the audio file.

18. The method of selling digital audio files in claim 17, wherein:
the step of broadcasting the signal includes transmitting with the signal associated audio file information; and
the step of receiving the satellite signal includes the step of displaying the associated audio information on a tuner display.

19. The method of selling digital audio files in claim 14, wherein:
the step of transmitting the downloadable version of the audio file includes transmitting the version in an electronic format through a wireless network wherein the storage device includes wireless receiver means for receiving the electronic format.

20. The method of selling digital audio files in claim 14, wherein:
the purchase request includes one or more preselected storage devices and associated information regarding the storage devices; and
the step of transmitting the downloadable version uses the associated information regarding the storage devices for locating and downloading the audio file to the storage devices.

21. A business method according to claim 14, wherein:
the payment of royalty fees to licensors is determined according to the number of times an audio file is purchased by subscribers.

22. A business method according to claim 14, wherein:
the payment of royalty fees to licensors is determined by a one-time fee.

23. A business method according to claim 14, wherein:
the subscriber pays for the purchase of audio files per each purchase request.

24. A business method according to claim 14, wherein:
the subscriber pays for the purchase of audio files at a periodic rate.

25. A system of selling digital audio files broadcast through a subscriber radio service, including:
an audio file center maintaining digital audio files;
a transceiver operative to receive the broadcast of digital audio files through the subscriber radio service and further operative to transmit a purchase request;
a digital file storage device;
a computer system and network operative to process purchase requests, store and retrieve digital audio files from the audio file center, and download a selected digital audio file through the network to the digital storage device.

26. The system of selling digital audio files of claim 25, wherein:
the digital audio file center is in operative connection to the computer and network system.

27. The system of selling digital audio files of claim 25, wherein:
the transceiver includes an automatic purchase function operative to automatically purchase and download an audio digital file to the digital storage device.

28. The system of selling digital audio files of claim 25, wherein:
the selected digital audio file is downloaded to multiple digital storage devices.

29. The system of selling digital audio files of claim 25, wherein:
the transceiver purchases and automatically stores a digital audio file currently broadcast.
